(19) United States
(12) Patent Application Publication
(10) Pub. No.: US 2026/0286840 A1
(43) Pub. Date: Sep. 24, 2026

(54) SYSTEM AND METHOD FOR BARRIER TESTING INJECTION XMAS TREE

(71) Applicant: TECHNIP UK LIMITED, Newcastle Upon Tyne (GB)

(72) Inventors: Ian Butler, Newcastle Upon Tyne (GB); Nicholas Gatherar, Newcastle Upon Tyne (GB)

(21) Appl. No.: 19/162,759

(22) PCT Filed: Feb. 26, 2024
(86) PCT No.: PCT/GB2024/050511

§ 371 Date: Sep. 5, 2025

(30) Foreign Application Priority Data
Mar. 8, 2023 (GB) 2303413.5

(51) Int. Cl. E21B 47/001; E21B 33/035; E21B 34/04

(52) U.S. Cl. CPC E21B 47/001; E21B 33/035; E21B 34/04

(57) ABSTRACT

A system for barrier testing of a Xmas tree injection system is disclosed. The Xmas tree comprises a fluid line between two or more barrier valves, one of the barrier valves of the two barrier valves being an upstream barrier valve closer to a reservoir and the other barrier valve being a downstream barrier valve closer to an environment; and at least one pressure monitoring device. The system is configured to provide fluid at different test pressures to the fluid line between the downstream barrier valve and the upstream barrier valve. The system comprises a first fluid connection line from a main injection line to a pressure increasing unit, with one or more valves positioned in the first connection line; and a second fluid connection line from the pressure increasing unit to a first connection point on the fluid line between the downstream barrier valve and the upstream barrier valve.

### TECHNICAL FIELD

The present disclosure relates to a system and a method for barrier testing. More particularly, the present disclosure relates to a system for barrier testing barrier valves of a Xmas tree injection system and a method for the same, mainly for the Carbon Capture and Storage (CCS) industry but also applicable to any fluid, gas and liquid, injection application, especially where there is no service line to the top side, where there is only one line pressure available subsea.

### BACKGROUND

Barriers, valves, in the oil and gas industry are required to be tested regularly to ensure barrier integrity. Such testing and frequency of testing are regulated and can be as often as once a month. Requirements for the CCS industry are still to be determined, however, it is anticipated that barrier elements will still require some form of regular testing. How to provide a system and a method for testing if barrier valves are intact, for a Xmas tree injection system, is a problem. How to make barrier testing cost-effective is a problem. How to cost-effectively provide arrangements and systems for conducting barrier testing is a problem. How to minimize the time for conducting barrier testing is a problem. It is desirable to test barriers, valves, of a Xmas tree injection system, especially in the CCS industry, but also applicable to any fluid, gas and liquid, injection application. It is desirable to provide and conduct barrier testing where there is no service line to the top side, and where there is only one line pressure available subsea.

A further technical problem is that any part of a solution must function without a possibility to fail, fulfil technical and legal requirements, and is easy to use. It is desirable that any solution be simple, inexpensive to produce, and reliable. It is further a technical problem to avoid cumbersome arrangements that are expensive to manufacture or assemble. It is desirable that any part of the solution, or at least some parts of the solution, can be retrieved or interchanged.

### SUMMARY

Embodiments of the present disclosure provide a system and a method for barrier testing a Xmas tree injection system. The system and the method for barrier testing may be used for any other subsea valve configuration that needs barrier testing of a Xmas tree injection system.

The embodiments disclosed herein eliminate the need for a service line for individual well barrier testing. The claimed system comprises a pressure increasing unit, fluid lines, and valves. Embodiments include a pressure intensifier, for example, a subsea pump, and a valve setup where fluid may be tapped off the main injection line, and vented by opening the barrier element upon conclusion of testing. The claimed system and method enables the manipulation of pressure for barrier testing, i.e., to set up the differential pressure required for barrier testing, in the same way as if pressure were from the topside via the service line for individual well barrier testing.

According to one embodiment, a system for barrier testing of a Xmas tree injection system is disclosed. The Xmas tree is subsea and comprises a fluid line between a set of two or more barrier valves, one of the barrier valves of the set of two barrier valves being an upstream barrier valve closer to a reservoir and the other barrier valve being a downstream barrier valve closer to an environment, and at least one pressure monitoring devices in the fluid line and downstream of the downstream barrier valve. The system is configured to provide fluid at different test pressures to the fluid line between the downstream barrier valve and the upstream barrier valve. The downstream barrier valve can be either within the Xmas tree or alternatively in the tubing (i.e., surface-controlled subsurface safety valve (SCSSV)). The system comprises a first fluid connection line from a main injection line, or a fluid source, to a pressure increasing unit, with one or more valves positioned in the first fluid connection line. The system comprises a second fluid connection line from the pressure increasing unit to a first connection point on the fluid line between the downstream barrier valve and the upstream barrier valve, with one or more valves positioned in the second fluid connection line.

According to one embodiment, the main injection line may be a carbon dioxide injection line, such as a liquid carbon dioxide injection line. The main injection line may be the only available pressure line subsea. That is, there is no service line from the claimed system to the top side, or from the Xmas tree injection system to the topside.

According to one embodiment, the pressure increasing unit may be connected to a valve configuration which enables it to either pump fluid in or draw fluid out of the fluid line and other connection lines. The pressure increasing unit may be an intensifier.

According to one embodiment, the system may further comprise a first cross over line bypassing the pressure increasing unit, the cross over line connecting the first fluid connection line and the second fluid connection line. The system may further comprise a second cross over line bypassing the pressure increasing unit, the cross over line connecting the first fluid connection line and the second fluid connection line; a first cross over valve positioned in the first cross over line; and a second cross over valve positioned in the second cross over line. The one or more valves positioned in the first connection line may comprise a first inboard isolation valve positioned between a first connection of the first cross over line and the first fluid connection line and a second connection of the second cross over line and the first fluid connection line; and the one or more valves positioned in the second fluid connection line may comprise a second inboard isolation valve positioned between a third connection of the first cross over line and the second fluid connection line and a fourth connection of the second cross over line and the second fluid connection line.

According to one embodiment, the system may further comprise one or more filters positioned in the first connection line and/or the second connection lines. The system may be arranged on a subsea Xmas tree, or on or in a manifold, or on a skid. The system may be arranged separately from, and fluidly connected to, the Xmas tree injection system.

According to one embodiment, the pressure increasing unit may be a battery driven pump, an electrically driven pump or a hydraulically driven pump, and the pressure increasing unit is retrievable. According to one embodiment, the fluid source is the main injection line. The fluid supply for the pressure increasing unit may come from the main injection line. The system may further comprise a storage for carbon dioxide, for example, a subsea well for storage or a liquid carbon dioxide storage subsea.

A method for barrier testing with the system, according to any one of the preceding embodiments, may comprise the following: closing the downstream barrier valve and the upstream barrier valve; increasing pressure, or decreasing pressure, in the fluid line between the downstream barrier valve and the upstream barrier valve using the pressure increasing unit, the pressure increasing unit using fluid from the main injection line; and keeping the increased pressure, or in the decreased pressure, for a predetermined time period and check at least one of the pressure monitoring devices to detect pressure changes.

According to at least one embodiment, a method for barrier testing of a Xmas tree injection system according to any one of the embodiments described herein, for testing with a test pressure above a pressure of the reservoir, is disclosed. The method comprises open the one or more valves positioned in the first connection line, open the one or more valves positioned in the second fluid connection line, close the crossover valves, and use the pressure increasing unit to increase the fluid test pressure in the fluid line to the desired barrier test pressure value, using fluid from the injection line.

According to at least one embodiment, a method for barrier testing of a Xmas tree injection system according to any one of the embodiments described herein, for testing with a test pressure below a pressure of the reservoir, is disclosed. The method comprises closing inboard isolation valves, opening the outboard valves, opening the crossover valves and using the pressure increasing unit to reduce the fluid pressure in the fluid line to the desired barrier test pressure value.

According to at least one embodiment, a method for barrier testing a master valve, the master valve being the upstream barrier valve, is disclosed. The method comprises closing the master valve, opening the one or more valves positioned in the first connection line, opening the one or more valves positioned in the second fluid connection line, closing the crossover valves, and using the pressure increasing unit to increase the fluid test pressure in the fluid line to the desired barrier test pressure value for the master valve, keeping the pressure for a predetermined time period and checking the pressure monitoring devices in the fluid line to detect pressure changes. This method for barrier testing a master valve may be a method for testing with a test pressure above a pressure of the reservoir.

According to at least one embodiment, a method for barrier testing a wing valve, the wing valve being the downstream barrier valve, is disclosed. The method comprises closing the wing valve, opening the one or more valves positioned in the first connection line, opening the one or more valves positioned in the second fluid connection line, closing the crossover valves, and using the pressure increasing unit to increase the fluid test pressure in the fluid line to the desired barrier test pressure value for the wing valve, keeping the pressure for a predetermined time period and checking the pressure monitoring devices in the fluid line to detect pressure changes. This method for barrier testing a wing valve may be a method for testing with a test pressure above a pressure of the reservoir.

According to at least one embodiment, the pressure increasing unit may use fluid from injection line and pump it into the test cavity or alternatively, may use the fluid from the test cavity and pump it into the injection line.

At least one of the above embodiments provides a system and method for testing if barrier valves are intact, and one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The accompanying drawings illustrate presently example embodiments of the disclosure and serve to explain, by way of example, the principles of the disclosure.

FIG. 1 is a diagrammatic illustration, a flow chart, of a system for barrier testing according to an example embodiment of the disclosure; and

FIG. 2 is a diagrammatic illustration, a flow chart, of a method for barrier testing with the system according to an example embodiment of the disclosure.

### DETAILED DESCRIPTION

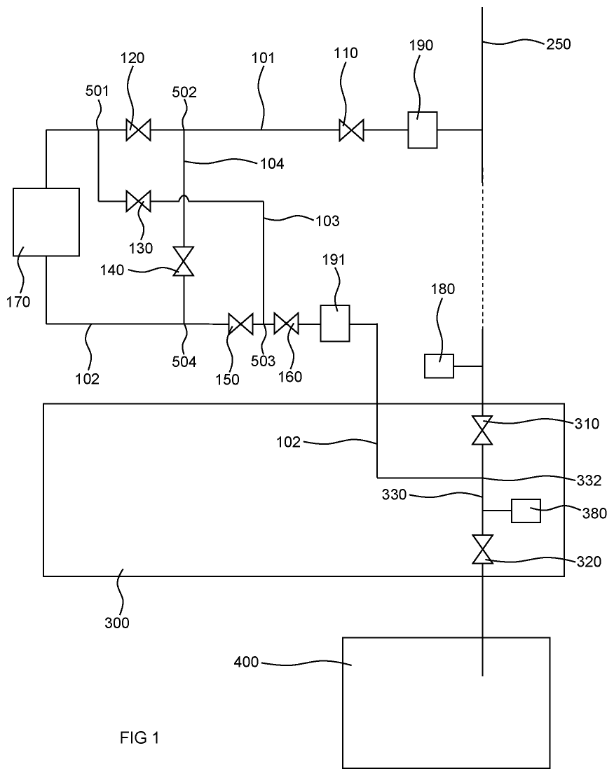

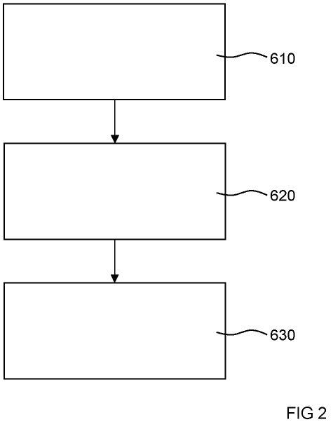

FIG. 1 is a diagrammatic illustration of a system for barrier testing of a Christmas (Xmas) tree injection system 300. In embodiments, the Xmas tree injection system 300 is connected to a reservoir 400 in the usual manner, for example, to a well 400 or to a tubing hanger 400. In embodiments, an injection line 250 extends from the main injection supply to the Xmas tree injection system 300. The system in FIG. 1 may be a CCS injection system, for example, for injection of carbon dioxide into a subsea well for storage. FIGS. 1 and 2 illustrate embodiments of a system for barrier testing barrier valves of a Xmas tree injection system and a method for the same, mainly for the CCS industry but also applicable to any fluid, gas and liquid, injection application, especially where there is no service line to the top side, where there is only one line pressure available subsea. FIG. 1 shows the system, and FIG. 2 shows the method for barrier testing with the system.

It is desirable to avoid having a separate service line in the umbilical between topside and subsea to realise the required pressure for the barrier testing valves in a Xmas tree system. The pressure in such a separate service line is controlled from the topside and is set higher or lower than the well shut-in pressure. It is anticipated that at least some Xmas trees for CCS applications will be electrified to allow for a more cost-effective umbilical solution. This cost saving would be negated if a hydraulic line were required for barrier testing.

Turning to FIG. 1, a system for barrier testing of a Xmas tree injection system 300 is illustrated. The Xmas tree is subsea and comprises a fluid line 330. The fluid line 330 is at least between a set of two barrier valves, or more valves, that are to be tested. One of the barrier valves of the set of two barrier valves being an upstream barrier valve 320 closer to a reservoir 400 and the other barrier valve being a downstream barrier valve 310 closer to environment. The upstream barrier valve 320 may, for example, be a master valve 320, and the downstream barrier valve 310 may be, for example, a wing valve 310. The Xmas tree also comprises at least one pressure monitoring device 180, 380 each in the fluid line 330 and downstream of the downstream barrier valve 310. One or more of the pressure monitoring devices 180 is in the fluid line 330, and one or more of the pressure monitoring devices 380 is downstream of the downstream barrier valve 310. In this way, different pressures may be monitored within the Xmas tree and the Xmas tree injection system 300. The system is configured to provide fluid at different test pressures to the fluid line 330 between the downstream barrier valve 310 and the upstream barrier valve 320. Hereby, at least the downstream barrier valve 310 and the upstream barrier valve 320 can be barrier tested. Other valves, sealing, or fluid lines within the Xmas tree injection system or upstream tubing may also be barrier tested. The system allows the creation of a differential pressure that would decay if the valve barrier is not intact. This is detected by the at least one pressure monitoring device 180, 380 of the system during the testing.

The system comprises a first fluid connection line 101 from a main injection line 250 to a pressure increasing unit 170. In embodiments, the main injection line 250 is a fluid source 250 to the Xmas tree injection system 300. In embodiments, the fluid source 250 is the main injection line 250 into the Xmas tree injection system 300. In embodiments, the first fluid connection line 101 allows fluid to be channelled between the main injection line 250 and the pressure increasing unit 170. In embodiments, the main injection line 250 is connected for injecting fluid into the fluid line 330. In embodiments, the Xmas tree injection system 300 is configured for carbon dioxide injection and storage, for example, storage of carbon dioxide in the well 400. In embodiments, the main injection line 250 is a carbon dioxide injection line. In further embodiments, the carbon dioxide injection line is a liquid carbon dioxide injection line. In some embodiments, the main injection line 250 may be the only available pressure line subsea. In some embodiments, the main injection line 250 may be the only single pressure line for the system for barrier testing. It may be so that there is no service line for fluid from the system to the top side, or from the Xmas tree injection system to the topside.

The system also comprises one or more valves 110, 120 positioned in the first fluid connection line 101. The valves 110, 120 may be opened or closed and regulate the fluid channelled in the first fluid connection line 101 between the fluid source 250 and the pressure increasing unit 170.

The system comprises a second fluid connection line 102 from the pressure increasing unit 170 to a first connection point 332. The first connection point 332 is on the fluid line 330 between the downstream barrier valve 310 and the upstream barrier valve 320. In embodiments, the second fluid connection line 102 allows fluid to be channelled between the pressure increasing unit 170 and the first connection point 332, that is, between the pressure increasing unit 170 and the fluid line 330.

The system also comprises one or more valves 150, 160 positioned in the second fluid connection line 102. The valves 150, 160 may be opened or closed and regulate the fluid channelled in the second fluid connection line 102 between the pressure increasing unit 170 and the first connection point 332.

The system according to FIG. 1 may also comprise one or more crossover line 103, 104 with one or more crossover valve 130, 140 to allow the pressure increasing unit 170 to either draw fluid out of the fluid line 330 or pump fluid into the fluid line 330. According to one embodiment, the system comprises a first cross over line 103 bypassing the pressure increasing unit 170, the cross over line 103 connecting the first fluid connection line 101 and the second fluid connection line 102. According to one embodiment, the system comprises a second cross over line 104 bypassing the pressure increasing unit 170, the cross over line 104 connecting the first fluid connection line 101 and the second fluid connection line 102. In some embodiments, the system may also comprise a first cross over valve 130 positioned in the first cross over line 103, and a second cross over valve 140 positioned in the second cross over line 104. In embodiments, the one or more valves 110, 120 positioned in the first connection line 101 comprises a first inboard isolation valve 120 positioned between, on one hand, a first connection 501 of the first cross over line 103 and the first fluid connection line 101 and, on the other hand, a second connection 502 of the second cross over line 104 and the first fluid connection line 101. In embodiments, the one or more valves 150, 160 positioned in the second fluid connection line 102 comprises a second inboard isolation valve 150 positioned between, on one hand, a third connection 503 of the first cross over line 103 and the second fluid connection line 102 and, on the other hand, a fourth connection 504 of the second cross over line 104 and the second fluid connection line 102. This may allow the pressure increasing unit 170 to either draw fluid out of the fluid line 330 or pump fluid into the fluid line 330. Instead of this arrangement, or in addition, one or more three-way valves may be used to achieve the same. The valve 110 may be called a first outboard valve 110 and may be positioned between the second connection 502 and the injection line 250. The valve 160 may be called a second outboard valve 160 and may be positioned between the third connection 503 and the first connection point 332.

The valve positions, open or closed, of the valves 110-160 in FIG. 1 for the pressure increasing unit 170 to either draw fluid out of the fluid line 330 or pump fluid in to into the fluid line 330 are the following. Assuming that the pressure increasing unit 170 can only pump fluid in the downwards direction in FIG. 1, that is, from point 501 to point 504. For the pressure increasing unit 170 to pump fluid into the fluid line 330, the valves 110, 120, 150, and 160 are open, and valves 130 and 140 are closed. For the pressure increasing unit 170 to pump fluid out of the fluid line 330, the valves 110, 130, 140, and 160 are open, and valves 120 and 150 are closed.

Turning to FIG. 1, in embodiments, and as described above, the pressure increasing unit 170 is connected to a valve configuration which enables it to either pump fluid in or draw fluid out of the connection lines. This allows the system to be a functional and robust system with a low possibility of malfunction. In embodiments, the pressure increasing unit 170 is retrievable. In embodiments, the pressure increasing device 170 is a pump driven by electricity, or driven by the fluid from the fluid source 250, for example, a service flow line, or be a pressure intensifier creating a higher pressure by different diameter pistons at inlet and outlet sides.

In embodiments, the pressure increasing unit 170 and/or the associated valves 110-160 is part of a separately retrievable unit, or is part of a remotely operated vehicle, ROV, skid systems with local hydraulic power generation. In an embodiments, for an electrically powered pressure increasing unit 170, as the testing and hence pressure increasing, pumping, is required only intermittently, electric power to the pressure increasing unit 170 is stored in batteries subsea, providing a solution that allows an all-electric subsea systems and eliminates the need for a subsea infrastructure designed for a peak power demand. According to one embodiment, the pressure increasing unit 170 comprises a pump for pumping fluid either to or from the fluid line 330. According to one embodiment, the pressure increasing unit 170 is an intensifier. The intensifier may increase the fluid pressure so as to enable fluid to be provided either to or from the fluid line 330 at a higher pressure than a pump or accumulator alone can provide.

The system is configured and arranged such that fluid at the different test pressures may be provided to the fluid line 330 between the barrier valves 310, 320 for testing of the barrier valves 310, 320. By arranging the fluid connection lines, the valves, and the pressure increasing unit 170 as described, the two or more barrier valves may be tested if they are intact. Instead of having to use a dedicated service line for testing, an existing fluid source may be used. With the system, test pressures may be set different, higher or lower, than the well, the reservoir 400, the shut-in pressure. This creates a differential pressure that would decay if the barrier valves are not intact. In embodiments, the decay is monitored by the pressure monitoring devices 180, 380 of the system during the testing. This is also further described below.

Turning to FIG. 1, in embodiments, the system further comprises one or more filters 190, 191 positioned in one, or both, of the two connection lines 101, 102. In embodiments, the filters 190, 191 are positioned in the first fluid connection line 101 and/or second connection line 102. The filters 190, 191 may allow the fluid to pass but stop any other contaminants. In embodiments, the filters 190, 191 are subsea and retrievable.

According to one embodiment, the system is arranged on a subsea Xmas tree, or on or in a manifold, or on a separate skid. In other embodiments, the system is added to an already existing Xmas tree injection system 300, or the system is incorporated to a new Xmas tree injection system 300.

According to one embodiment, one or more elements of the system are arranged on a subsea Xmas tree, or on or in a manifold, or on a skid. In other embodiments, the system is a separate system added to a Xmas tree injection system 300.

According to one embodiment, the system is arranged separately from, and fluidly connected to, the Xmas tree injection system 300. In embodiments, the system is separately arranged on a skid and placed next to the Xmas tree injection system 300. In embodiments, the system is only fluidly connected to the Xmas tree injection system 300. In embodiments, the fluid connection is done with the second fluid connection line 102 from the pressure increasing unit 170 to the first connection point 332 on the fluid line 330 between the downstream barrier valve 310 and the upstream barrier valve 320. In embodiments, the system is connected to one or more Xmas trees or other valves systems where regular barrier testing is required or operationally beneficial.

According to one embodiment, the pressure increasing unit 170 is a battery driven pump, or a direct electric driven pump, or a hydraulically driven pump, or a pressure intensifier. In embodiments, the hydraulically driven pump is driven from the main injection line 250. In embodiments, the pressure increasing unit 170 is retrievable. In embodiments, the pressure increasing unit 170 is removably connected to the system, such that it can be retrieved, for example, by a remotely operated vehicle (ROV). This allows the pressure increasing unit 170 to be exchanged or serviced.

According to one embodiment, the system described herein is configured to be retrievable. In embodiments, the fluid connection lines 101, 102, the pressure increasing unit 170, the filter 190, 191, the valves 110, 120, 130, 140, 150, 160, are retrievable, independently or together. In embodiments, the pressure increasing unit 170 and the filter 190, 191 may be each separately and independently retrievable from the rest. This may require further valves before and after the pressure increasing unit 170 and the filters 190, 191.

According to one embodiment, the fluid source 250 is the main injection line to the Xmas tree injection system 300. This may also be the fluid used for testing the barriers. This removes the requirement for a separate fluid line for barrier testing.

According to one embodiment, the system for barrier testing of a Xmas tree injection system 300 does not comprise, or require, any further element or elements. The system may need no further valves, fluid connection lines, pressure increasing units, fluid receiving unit, or any other element, for realizing the system for barrier testing of a Xmas tree injection system. According to one embodiment of the system described herein, the two fluid connection lines 101, 102 connect the pressure increasing unit 170, the filters 190, 191, the valves 110, 120, 130, 140, 150, 160, directly to each other as described herein, excluding other elements. According to one embodiment, there are no further fluid connection lines between the pressure increasing unit 170 and the valves 110, 120, 130, 140, 150, 160.

According to one embodiment, all the valves 110, 120, 130, 140, 150, 160 are remotely controllable so that the valves may be opened or closed according to instructions from the topside. According to one embodiment, the pressure increasing device 170 is remotely controllable so that it may be operated according to instructions from the topside. In embodiments, the pressure monitoring devices 180, 380 are remotely readable, such that their monitored pressure may be taken at the topside. In embodiments, the valves 110, 120, 130, 140, 150, 160, and/or the pressure increasing device 170 are remotely controllable by using a ROV. In embodiments, the pressure monitoring devices 180, 380 are remotely readable by using a ROV. In embodiments, the valves required for barrier testing are remotely controllable with local back-up, for example, local ROV back-up. In embodiments, the valves required for system replacement are controlled locally by ROV during replacement.

Turning to FIG. 2, a method for barrier testing, using the system illustrated by FIG. 1 and/or described above, is illustrated. The method comprises the following steps. Closing 610 the downstream barrier valve 310 and the upstream barrier valve 320. Increasing 620 pressure, or decreasing pressure, in the fluid line 330 between the downstream barrier valve 310 and the upstream barrier valve 320 using the pressure increasing unit 170, the pressure increasing unit 170 using fluid from the main injection line 250. Keeping 630 the increased pressure, or in the decreased pressure, for a predetermined time period and checking at least one of the pressure monitoring devices 180, 380 to detect pressure changes. If a pressure change is detected over time, then the barriers, the valves 310, 320, are not intact. Thus, a method for barrier testing with the system according to any one of the embodiments described herein, or any combination of embodiments described herein, is disclosed. The method may further set out opened or closed positions of the valves 110, 120, 130, 140, 150, 160 and how the pressure increasing unit 170 is operated to test if the barrier valves are intact or leak. This allows the system to provide fluid at different test pressures to the fluid line 330 between the downstream barrier valve 310 and the upstream barrier valve 320.

Described is a method for barrier testing with the system according to any one of the embodiments described herein, or any combination of embodiments described herein, for testing with a test pressure above a pressure of the reservoir 400. That is, for testing the barrier valves with a higher pressure than the well shut-in pressure, for example, at a higher pressure than the pressure in the injection line 250. The method comprises opening the one or more valves 110, 120 positioned in the first connection line 101, opening the one or more valves 150, 160 positioned in the second fluid connection line 102, closing the crossover valves 130, 140, and using the pressure increasing unit 170 to increase the fluid test pressure in the fluid line 330 to the desired barrier test pressure value, using fluid from the injection line 250. In this way, the test pressure is increased to the selected test pressure in the fluid line 330. The test pressure is then held at this level, and since the downstream barrier valve 310 and the upstream barrier valve 320 are closed, a change, for example, a decrease, in the pressure level detected by the pressure monitoring device 380 indicates that the barrier valves are not intact.

Described is a method for barrier testing with the system according to any one of the embodiments described herein, or any combination of embodiments described herein, for testing with a test pressure below a pressure of the reservoir 400. That is, for testing the barrier valves with a lower pressure than the well shut-in pressure, for example, at a lower pressure than the pressure in the injection line 250. The method comprises closing inboard isolation valves 120, 150, opening the outboard valves 110, 160, opening the crossover valves 130, 140 and using the pressure increasing unit 170 to reduce the fluid pressure in the fluid line 330 to the desired barrier test pressure value. Fluid within the fluid line 330 is transferred by the pressure increasing unit 170, and such transfer of fluid reduces the pressure within the Xmas tree injection system 300. In this way, the test pressure is reduced to the selected test pressure in the fluid line 330. The test pressure is then held at this level, and since the downstream barrier valve 310 and the upstream barrier valve 320 are closed, a change, for example, an increase, in the pressure level detected by the pressure monitoring device 380 indicates that the barrier valve is not intact.

According to one embodiment, the method may include testing a master valve 320. Described is a method according to any one of the embodiments described herein, or any combination of embodiments described herein, for barrier testing a master valve 320. In FIG. 1, the master valve is the upstream barrier valve 320. The method comprises closing the master valve 320, opening the one or more valves 110, 120 positioned in the first connection line 101, opening the one or more valves 150, 160 positioned in the second fluid connection line 102, closing the crossover valves 130, 140, and using the pressure increasing unit 170 to increase the fluid test pressure in the fluid line 330 to the desired barrier test pressure value for the master valve 320, keeping the pressure for a predetermined time period and checking the pressure monitoring devices 380 in the fluid line 330 to detect pressure changes. If a pressure decrease is detected, then the master valve 320 is not intact. Instead of closing the downstream barrier valve 310, any other valve in the Xmas tree injection system 300 may be used to keep the test pressure for testing the master valve 320.

According to one embodiment, the method may include testing a wing valve 310. Described is a method according to any one of the embodiments described herein, or any combination of embodiments described herein, for barrier testing a wing valve 310. In FIG. 1, the wing valve is the downstream barrier valve 310. The method comprises closing the wing valve 310, opening the one or more valves 110, 120 positioned in the first connection line 101, opening the one or more valves 150, 160 positioned in the second fluid connection line 102, closing the crossover valves 130, 140, and using the pressure increasing unit 170 to increase the fluid test pressure in the fluid line 330 to the desired barrier test pressure value for the wing valve 310, keeping the pressure for a predetermined time period and checking the pressure monitoring devices 380 in the fluid line 330 to detect pressure changes. If a pressure decrease is detected, then the wing valve 310 is not intact. Instead of closing the upstream barrier valve 320, any other valve in the Xmas tree injection system 300 may be used to keep the test pressure for testing the wing valve 310.

According to one embodiment, the method may include using fluid from the main injection line 250. The method may comprise that the pressure increasing unit 170 uses fluid from the main injection line 250.

This written description uses examples to disclose the various embodiments disclosed herein, including the best mode, and also to enable any person skilled in the art to practice the embodiments, including making and using the system and performing the methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

1. A system for barrier testing of a Xmas tree injection system, the Xmas tree being subsea and comprising a fluid line between a set of two or more barrier valves, one of the barrier valves of the set of two barrier valves being an upstream barrier valve closer to a reservoir and the other barrier valve being a downstream barrier valve closer to an environment, and at least one pressure monitoring devices in each of the fluid line and downstream of the downstream barrier valve, the system comprising:
a first fluid connection line from a main injection line to a pressure increasing unit, with one or more valves positioned in the first connection line; and
a second fluid connection line from the pressure increasing unit to a first connection point on the fluid line between the downstream barrier valve and the upstream barrier valve, with one or more valves positioned in the second fluid connection line,
wherein the system is configured to provide fluid at different test pressures to the fluid line between the downstream barrier valve and the upstream barrier valve.

2. The system according to claim 1, wherein the main injection line is a carbon dioxide injection line.

3. The system according to claim 1, wherein the main injection line is the only available pressure line subsea.

4. The system according to claim 1, wherein the pressure increasing unit comprises a pump for pumping fluid either to or from the fluid line.

5. The system according to claim 1, wherein the pressure increasing unit is an intensifier.

6. The system according to claim 1, further comprising a first cross over line bypassing the pressure increasing unit, the cross over line connecting the first fluid connection line and the second fluid connection line.

7. The system according to claim 6, further comprising:
a second cross over line bypassing the pressure increasing unit, the cross over line connecting the first fluid connection line and the second fluid connection line;
a first cross over valve positioned in the first cross over line;
a second cross over valve positioned in the second cross over line;
the one or more valves positioned in the first connection line comprising a first inboard isolation valve positioned between a first connection of the first cross over line and the first fluid connection line and a second connection of the second cross over line and the first fluid connection line; and
the one or more valves positioned in the second fluid connection line comprising a second inboard isolation valve positioned between a third connection of the first cross over line and the second fluid connection line and a fourth connection of the second cross over line and the second fluid connection line.

8. The system according to claim 1, further comprising one or more filters positioned in one, or both, of the two connection lines.

9. The system according to claim 1, wherein the system is arranged separately from, and fluidly connected to, the Xmas.

10. The system according to claim 1, wherein the pressure increasing unit is a battery driven pump or a hydraulically driven pump, and the pressure increasing unit is retrievable.

11. The system, according to claim 1, wherein the fluid supply for the pressure increasing unit comes from the main injection line.

12. The system according to claim 1, further comprising a storage for carbon dioxide.

13. A method for barrier testing of a Xmas tree injection system, the Xmas tree being subsea and comprising a fluid line between a set of two or more barrier valves, one of the barrier valves of the set of two barrier valves being an upstream barrier valve closer to a reservoir and the other barrier valve being a downstream valve closer to an environment, and at least one pressure monitoring device in each of the fluid line and downstream of the downstream barrier valve, the method comprising:
closing the downstream barrier valve and the upstream barrier valve;
increasing pressure, or decreasing pressure, in a fluid line between the downstream barrier valve and the upstream barrier valve using a pressure increasing unit, the pressure increasing unit using fluid from a main injection line;
keeping the increased pressure, or the decreased pressure, for a predetermined time period; and
checking at least one of a pressure monitoring devices to detect pressure changes.

14. The method according to claim 13, when testing with a test pressure above a pressure of the reservoir, the method further comprising:
opening one or more valves positioned in a first connection line, the first connection line coupled to the main injection line and the pressure increasing unit;
opening one or more valves positioned in a second fluid connection line, the second fluid connection line coupled to the pressure increasing unit and the fluid line;
closing a set of crossover valves, the set of crossover valves including a first cross over valve positioned in a first cross over line that bypasses the pressure increasing unit and connects the first fluid connection line and the second connection line, and a second cross over valve positioned in a second cross over line that bypasses the pressure increasing unit and connects the first fluid connection line and the second fluid connection line; and
using the pressure increasing unit to increase a fluid test pressure in the fluid line to a desired barrier test pressure value using fluid from the injection line.

15. The method according to claim 13, when barrier testing a master valve, the master valve being the upstream barrier valve, the method further comprises:
closing the master valve;
opening the one or more valves positioned in the first connection line;
opening the one or more valves positioned in the second fluid connection line;
closing a set of crossover valves, the set of crossover valves including a first cross over valve positioned in a first cross over line that bypasses the pressure increasing unit and connects the first fluid connection line and the second connection line, and a second cross over valve positioned in a second cross over line that bypasses the pressure increasing unit and connects the first fluid connection line and the second fluid connection line;
using the pressure increasing unit to increase the fluid test pressure in the fluid line to a desired barrier test pressure value for the master valve;
keeping the fluid test pressure for a predetermined time period; and
checking the pressure monitoring devices in the fluid line to detect pressure changes.

16. The method according to claim 13, when testing with a test pressure below a pressure of the reservoir, the method further comprising:
closing a set of inboard isolation valves, the set of inboard isolation valves including a first isolation valve positioned between a first connection of the first cross over line and the first fluid connection line and a second connection of the second cross over line and the first fluid connection line, and a second isolation valve positioned between a third connection of the first cross over line and the second fluid connection line and a fourth connection of the second cross over line and the second fluid connection line;
opening a set outboard valves, the set of outboard valves including a first valve positioned in the first connection line and a second valve positioned in the second connection line;
opening a set of crossover valves, the set of crossover valves including a first cross over valve positioned in a first cross over line that bypasses the pressure increasing unit and connects the first fluid connection line and the second connection line, and a second cross over valve positioned in a second cross over line that bypasses the pressure increasing unit and connects the first fluid connection line and the second fluid connection line; and
using the pressure increasing unit to reduce a fluid pressure in the fluid line to a desired barrier test pressure value.

17. The method according to claim 13, when testing a wing valve, the wing valve being the downstream barrier valve, the method further comprising:
closing the wing valve;
opening one or more valves positioned in the first connection line;
opening one or more valves positioned in the second fluid connection line;
closing the crossover valves, the set of crossover valves including a first cross over valve positioned in a first cross over line that bypasses the pressure increasing unit and connects the first fluid connection line and the second connection line, and a second cross over valve positioned in a second cross over line that bypasses the pressure increasing unit and connects the first fluid connection line and the second fluid connection line;
using the pressure increasing unit to increase a fluid test pressure in the fluid line to a desired barrier test pressure value for the wing valve;
keeping the fluid test pressure for a predetermined time period; and
checking the pressure monitoring devices in the fluid line to detect pressure changes.
